(19) United States
(12) Patent Application Publication
(10) Pub. No.: US 2015/0323881 A1
(43) Pub. Date: Nov. 12, 2015

(54) IMAGE FORMING APPARATUS

(71) Applicant: CANON KABUSHIKI KAISHA, Tokyo (JP)

(72) Inventor: Yasuo Kamei, Tokyo (JP)

(21) Appl. No.: 14/701,286

(22) Filed: Apr. 30, 2015

(30) Foreign Application Priority Data
May 7, 2014 (JP) 2014-095910

(51) Int. Cl. G03G 15/00

(52) U.S. Cl. CPC G03G 15/043

(57) ABSTRACT

An image forming apparatus, including: a rotatable photosensitive member; a light source configured to emit a light beam; a rotary polygon mirror configured to deflect the light beam to scan a surface of the photosensitive member; a motor configured to rotate the rotary polygon mirror; a first rotation amount detecting unit configured to detect a rotation amount of the rotary polygon mirror; and a second rotation amount detecting unit configured to detect a rotation amount of the photosensitive member, wherein a first period of a first signal from the first rotation amount detecting unit and a second period of a second signal from the second rotation amount detecting unit have a relationship of an integral multiple, and wherein a rotation speed of the motor is controlled so that the first signal and the second signal are synchronized with each other while maintaining the relationship of the integral multiple.

### BACKGROUND OF THE INVENTION

1. Field of the Invention

The present invention relates to an image forming apparatus including a rotatable photosensitive member and a rotary polygon mirror.

2. Description of the Related Art

In a color image forming apparatus configured to form a color image (hereinafter referred to as “image forming apparatus”), a photosensitive drum configured to bear a toner image (hereinafter referred to as “photosensitive member”) is required to be driven so that a surface speed of the photosensitive member becomes a constant speed. When the surface speed of the photosensitive member fluctuates, an exposure position on a surface of the photosensitive member, which is to be exposed to a light beam, is deviated from a position originally required to be exposed. In view of the above, rotation of the photosensitive member is controlled so that the surface speed of the photosensitive member becomes a constant speed. However, the surface speed of the photosensitive member may be fluctuated due to a speed fluctuation of a motor configured to drive the photosensitive member, decentering of the photosensitive member, pitch unevenness of gears, shock of entry of a transfer sheet conveyed to the photosensitive member, or the like.

When the surface speed of the photosensitive member is higher than a target speed, a cumulative exposure light amount per unit area is decreased so that developing contrast becomes smaller, with the result that image density is decreased. The developing contrast herein indicates a difference between a surface potential of the photosensitive member exposed to the light beam and a developing bias voltage applied to a developing roller. In addition, the light beam scans the surface of the photosensitive member at a position on a downstream side with respect to the position originally required to be exposed in a sub-scanning direction, and hence a position of an image is deviated toward the downstream side. On the other hand, when the surface speed of the photosensitive member is lower than the target speed, the cumulative exposure light amount per unit area is increased so that the developing contrast becomes larger, with the result that the image density is increased. In addition, the light beam scans the surface of the photosensitive member at a position on an upstream side with respect to the position originally required to be exposed in the sub-scanning direction, and hence the position of the image is deviated toward the upstream side.

That is, the fluctuation of the surface speed of the photosensitive member not only causes unevenness of the developing contrast (unevenness of the image density), but also causes unevenness in pixel density in the sub-scanning direction. The unevenness of the developing contrast and the unevenness in pixel density cause an image failure such as banding (periodic strip-shaped unevenness in density) or color misregistration (positional deviation between colors superimposed on each other). In view of the above, Japanese Patent Application Laid-Open No. H10-003188 proposes a technology of changing a rotation speed of a rotary polygon mirror in accordance with a periodic fluctuation of a rotation speed of the photosensitive member.

In order to change the rotation speed of the rotary polygon mirror in accordance with the periodic fluctuation of the rotation speed of the photosensitive member, in Japanese Patent Application Laid-Open No. H10-003188, a motor is controlled in accordance with a signal indicating the rotation speed of the photosensitive member to change the rotation speed of the rotary polygon mirror. However, even when the rotation speed of the rotary polygon mirror is changed, the color misregistration occurs unless a synchronization relationship between the signal indicating the rotation speed of the photosensitive member and a signal indicating the rotation speed of the rotary polygon mirror is maintained. In view of the above, in order to maintain the synchronization relationship between the signal indicating the rotation speed of the photosensitive member and the signal indicating the rotation speed of the rotary polygon mirror, an additional synchronous signal is required to be generated.

However, when the synchronous signal is generated, computation for controlling the rotation speed of the rotary polygon mirror to follow the rotation speed of the photosensitive member becomes complicated, and hence a time period required for the computation becomes longer. When the time period required for the computation becomes longer, a timing for transmitting a control signal to a drive circuit configured to drive the motor of the rotary polygon mirror is delayed, with the result that correction for phase shift between the photosensitive member and the rotary polygon mirror is delayed. Accordingly, there is a problem in that a rotation amount of the rotary polygon mirror is not synchronized with a rotation amount of the photosensitive member.

### SUMMARY OF THE INVENTION

To address the above-mentioned problem, the present invention provides an image forming apparatus which synchronizes a rotation amount of a rotary polygon mirror and a rotation amount of a photosensitive member with each other.

In order to solve the above-mentioned problem, according to an embodiment, there is provided an image forming apparatus, comprising: a rotatable photosensitive member; a light source configured to emit a light beam; a rotary polygon mirror configured to deflect the light beam emitted from the light source so that the light beam scans a surface of the photosensitive member; a motor configured to rotate the rotary polygon mirror; a first rotation amount detecting unit configured to detect a rotation amount of the rotary polygon mirror; and a second rotation amount detecting unit configured to detect a rotation amount of the photosensitive member, wherein a first period of a first signal from the first rotation amount detecting unit and a second period of a second signal from the second rotation amount detecting unit have a relationship of an integral multiple, and wherein a rotation speed of the motor is controlled so that the first signal and the second signal are synchronized with each other while maintaining the relationship of the integral multiple.

Further features of the present invention will become apparent from the following description of exemplary embodiments with reference to the attached drawings.

### BRIEF DESCRIPTION OF THE DRAWINGS

FIG. 1 is a sectional view of an image forming apparatus.

FIG. 2 is a diagram illustrating a drive mechanism of a photosensitive member.

FIG. 3 is a block diagram illustrating a configuration of a light scanning device.

FIG. 4 is a diagram illustrating a relationship between a BD signal and an encoder signal.

FIG. 5 is a diagram illustrating the relationship between the BD signal and the encoder signal in a case of n=1.

FIG. 6 is a diagram illustrating the relationship between the BD signal and the encoder signal in a case of n=2.

### DESCRIPTION OF THE EMBODIMENTS

Now, embodiments of the present invention will be described with reference to the drawings.

Image Forming Apparatus

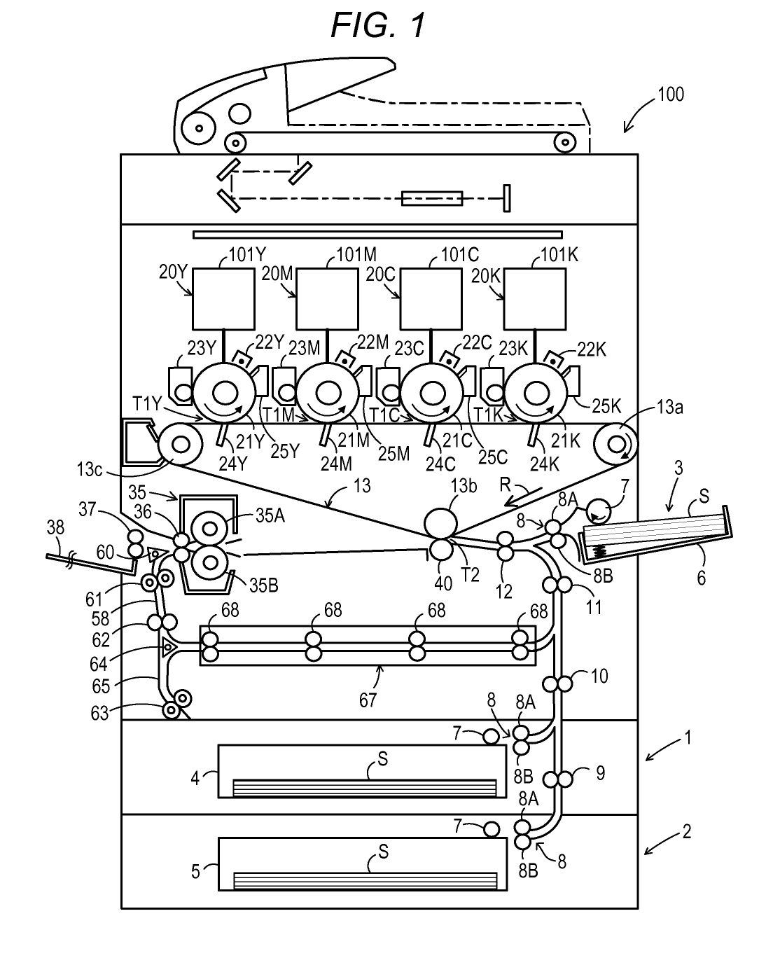

FIG. 1 is a sectional view of an image forming apparatus 100. The image forming apparatus 100 includes a plurality of image forming portions 20 (20Y, 20M, 20C, and 20K). The image forming portion 20Y is configured to form a yellow image using yellow toner. The image forming portion 20M is configured to form a magenta image using magenta toner. The image forming portion 20C is configured to form a cyan image using cyan toner. The image forming portion 20K is configured to form a black image using black toner. The four image forming portions 20 have the same structure except for the colors of the developer (toner), and hence, in the following description, the suffixes Y, M, C, and K are omitted from reference symbols unless otherwise necessary.

The image forming portions 20 include rotatable photosensitive drums 21 serving as image bearing members (hereinafter referred to as “photosensitive members”), respectively. Around the photosensitive members 21, there are arranged charging devices 22, light scanning devices 101, developing devices 23, primary transfer devices 24, and drum cleaning devices 25, respectively. An intermediate transfer belt (endless belt) 13 serving as an intermediate transfer member is arranged below the photosensitive members 21.

The rotatable intermediate transfer belt (image bearing member) 13 is stretched around a drive roller 13a, a secondary transfer opposed roller 13b, and a tension roller 13c. The intermediate transfer belt 13 rotates in a clockwise direction indicated by the arrow R of FIG. 1 (hereinafter referred to as “rotation direction R”) at the time of image formation. Along the rotation direction R of the intermediate transfer belt 13, the yellow image forming portion 20Y, the magenta image forming portion 20M, the cyan image forming portion 20C, and the black image forming portion 20K are arranged in the stated order.

The primary transfer devices 24 are provided opposite to the photosensitive members 21 across the intermediate transfer belt 13, respectively. The primary transfer device 24 forms a primary transfer portion T1 between the intermediate transfer belt 13 and the photosensitive member 21. A secondary transfer roller 40 is provided opposite to the secondary transfer opposed roller 13b across the intermediate transfer belt 13. The secondary transfer roller 40 forms a secondary transfer portion T2 between the intermediate transfer belt 13 and the secondary transfer roller 40.

A fixing device 35 is arranged on a downstream side with respect to the secondary transfer portion T2 in a conveyance direction of a transfer sheet (hereinafter referred to as “recording medium”) S. The fixing device 35 includes a fixing roller 35A and a pressure roller 35B, and a nip is formed between the fixing roller 35A and the pressure roller 35B.

The image forming apparatus 100 includes two cassette sheet-feeding portions 1 and 2 and one manual sheet-feeding portion 3. The recording medium S is fed selectively from the sheet-feeding portion 1, 2, or 3. The recording media S are stacked on each of a cassette 4 of the sheet-feeding portion 1, a cassette 5 of the sheet-feeding portion 2, and a tray 6 of the sheet-feeding portion 3. The recording media S are fed by a pick-up roller 7 in an order from an uppermost sheet.

The recording media S, which are fed by the pick-up roller 7, are separated one by one by a separation roller pair 8 including a feed roller 8A serving as a conveyance member and a retard roller 8B serving as a separation member, and thus each separated recording medium S is fed to a registration roller pair 12 in a rotation stopped state. The recording medium S, which is fed from the cassette 4, is conveyed to the registration roller pair 12 through a conveyance route by a plurality of conveyance roller pairs 10 and 11. The recording medium S, which is fed from the cassette 5, is conveyed to the registration roller pair 12 through the conveyance route by a plurality of conveyance roller pairs 9, 10, and 11. A leading edge portion of the recording medium S, which is conveyed to the registration roller pair 12, strikes against a nip of the registration roller pair 12, and thus the recording medium S is deflected to be temporarily stopped. When the recording medium S is deflected, skew of the recording medium S is corrected.

Image Forming Process

Next, an image forming process of the image forming apparatus 100 will be described. The image forming processes of the four image forming portions 20 are the same, and hence the image forming process of the yellow image forming portion 20Y will be described. A part of description of the image forming processes of the magenta image forming portion 20M, the cyan image forming portion 20C, and the black image forming portion 20K is omitted.

The charging device 22Y uniformly charges a surface of the photosensitive member 21Y. The light scanning device 101Y irradiates the uniformly charged surface of the photosensitive member 21Y with laser light (hereinafter referred to as “light beam”) LY modulated in accordance with image information for yellow, to thereby form an electrostatic latent image on the photosensitive member 21Y. The developing device 23Y develops the electrostatic latent image with the yellow toner (developer) into a yellow toner image. The primary transfer device 24Y primarily transfers the yellow toner image, which is formed on the photosensitive member 21Y, onto the intermediate transfer belt 13 in the primary transfer portion T1Y. The yellow toner, which remains on the photosensitive member 21Y after the primary transfer, is removed by the drum cleaning device 25Y, and the photosensitive member 21Y prepares for a next image formation.

After a predetermined time period has elapsed since the start of scanning the photosensitive member 21Y with the light beam LY, the light scanning device 101M starts to scan the photosensitive member 21M with a light beam LM modulated in accordance with image information for magenta, to thereby form an electrostatic latent image on the photosensitive member 21M. The electrostatic latent image is developed with the magenta toner into a magenta toner image by the developing device 23M. In the primary transfer portion T1M, the magenta toner image is transferred by the primary transfer device 24M onto the yellow toner image on the intermediate transfer belt 13 accurately in a superimposed manner.

After a predetermined time period has elapsed since the start of scanning the photosensitive member 21M with the light beam LM, the light scanning device 101C starts to scan the photosensitive member 21C with a light beam LC modulated in accordance with image information for cyan, to thereby form an electrostatic latent image on the photosensitive member 21C. The electrostatic latent image is developed with the cyan toner into a cyan toner image by the developing device 23C. In the primary transfer portion TIC, the cyan toner image is transferred by the primary transfer device 24C onto the magenta toner image on the intermediate transfer belt 13 accurately in a superimposed manner.

After a predetermined time period has elapsed since the start of scanning the photosensitive member 21C with the light beam LC, the light scanning device 101K starts to scan the photosensitive member 21K with a light beam LK modulated in accordance with image information for black, to thereby form an electrostatic latent image on the photosensitive member 21K. The electrostatic latent image is developed with the black toner into a black toner image by the developing device 23K. In the primary transfer portion T1K, the black toner image is transferred by the primary transfer device 24K onto the cyan toner image on the intermediate transfer belt 13 accurately in a superimposed manner.

In this manner, the four-color toner images are superimposed on the intermediate transfer belt 13. The recording medium S, which is conveyed from the sheet-feeding portion 1, 2, or 3, is conveyed to the secondary transfer portion T2 by the registration roller pair 12 in synchronization with the toner images on the intermediate transfer belt 13. In the secondary transfer portion T2, the four-color toner images, which are superimposed on the intermediate transfer belt 13, are secondarily transferred onto the recording medium S by the secondary transfer roller 40 in a collective manner.

The recording medium S having the toner images transferred thereonto is conveyed to the nip formed between the fixing roller 35A and the pressure roller 35B of the fixing device 35. The fixing device 35 fixes the toner images onto the recording medium S by heating and pressurizing the recording medium S. In this manner, the recording medium S having the color image formed thereon is fed to a delivery roller pair 37 by a conveyance roller pair 36, and is further delivered onto a delivery tray 38 arranged outside the apparatus.

When a duplex printing mode of forming images on both sides of the recording medium S is selected, the conveyance direction of the recording medium S, which is conveyed by the conveyance roller pair 36, is switched by a flapper 60, and thus the recording medium S is conveyed to a reverse conveyance route 58 by conveyance rollers 61. The recording medium S is temporarily conveyed to a reverse route 65 by a conveyance roller pair 62, a flapper 64, and a conveyance roller pair 63. Then, the conveyance roller pair 63 is reversely rotated, and the conveyance direction of the recording medium S is switched by the flapper 64, to thereby convey the recording medium S from the reverse route 65 to a duplex conveyance route 67. In this manner, front and back surfaces of the recording medium S are reversed. By a plurality of conveyance roller pairs 68, the recording medium S is again conveyed to the registration roller pair 12 from the duplex conveyance route 67 through the conveyance roller pair 11. A toner image is transferred onto the back surface of the recording medium S in the secondary transfer portion T2. The toner image is fixed onto the back surface of the recording medium S in the fixing device 35. In this manner, the recording medium S having the images formed on both the sides is delivered onto the delivery tray 38 by the delivery roller pair 37.

Rotary Encoder

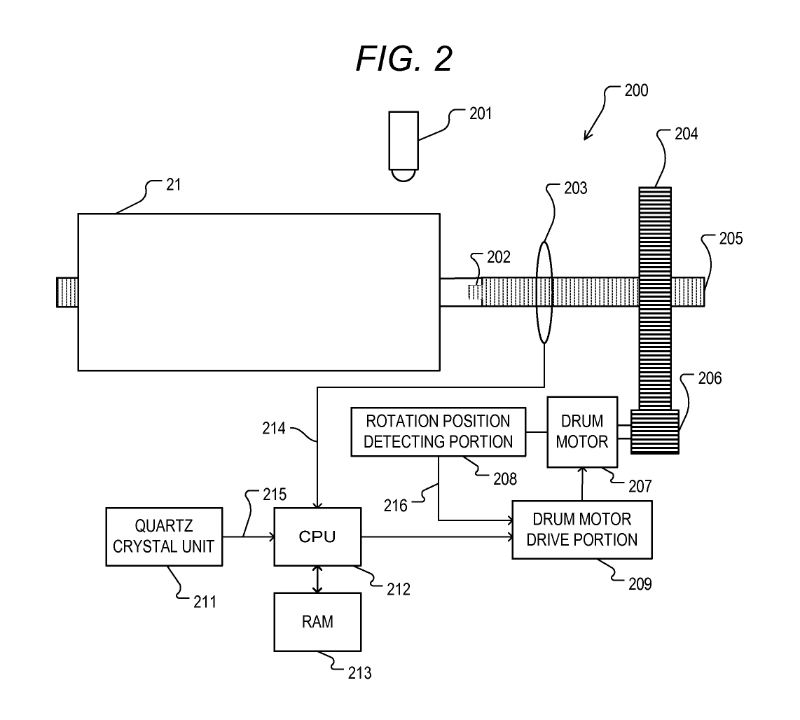

FIG. 2 is a diagram illustrating a drive mechanism 200 of the photosensitive member 21. The drive mechanisms 200 of the four image forming portions 20 are the same, and hence the suffixes Y, M, C, and K are omitted from reference symbols for description.

The photosensitive member 21 includes a coupling 202. The coupling 202 of the photosensitive member 21 is mechanically connected to a drum shaft (rotary shaft) 205. A speed reduction gear 204 and a rotary encoder (angular position detecting device) 203 are fixed to the drum shaft 205. The speed reduction gear 204 meshes with a motor shaft gear 206. The motor shaft gear 206 is fixed to a rotary shaft of a brushless DC motor (hereinafter referred to as “drum motor”) 207 serving as a drive source. Rotation of the drum motor 207 is transmitted to the drum shaft 205 through the motor shaft gear 206 and the speed reduction gear 204. With this, the photosensitive member 21 rotates integrally with the rotary encoder 203 due to a drive force of the drum motor 207.

A rotation position detecting portion 208 detects a rotation position of the drum motor 207 and outputs a rotation position signal 216 to a drum motor drive portion 209. Based on the rotation position signal 216, the drum motor drive portion 209 switches a phase of a phase current to be caused to flow through the drum motor 207 and adjusts a current amount of the phase current. In this manner, the drum motor drive portion 209 controls a rotation speed of the photosensitive member 21 through control of a rotation speed of the drum motor 207 based on a signal from a CPU (control unit) 212 and the rotation position signal 216.

The rotary encoder 203 functions as a surface movement distance detecting unit configured to detect a movement distance of a surface (hereinafter referred to as “surface movement distance”) of the rotating photosensitive member 21. The rotary encoder 203 outputs an encoder signal (angular position signal) 214 in accordance with an angular position of the rotating photosensitive member 21. The rotary encoder 203 outputs the encoder signal 214 to the CPU 212 in accordance with the rotation of the photosensitive member 21. The CPU 212 is electrically connected to each of the rotary encoder 203, the drum motor drive portion 209, a quartz crystal unit 211, and a RAM 213. The CPU 212 determines the surface movement distance of the photosensitive member 21 based on the encoder signal 214. Further, the CPU 212 counts a time interval of the encoder signal 214 based on a reference clock input from the quartz crystal unit 211. The RAM (storage device) 213 stores date to be used for the computation. The CPU 212 reads out the data from the RAM 213 at the time of the computation.

Note that, the surface movement distance of the photosensitive member 21 may be measured using, in place of the rotary encoder 203, a laser Doppler velocimeter (second rotation amount detecting unit) 201 illustrated in FIG. 2. Further, a plurality of marks formed on a surface of a region of the photosensitive member 21 excluding an image forming region along a rotation direction (sub-scanning direction C) of the photosensitive member 21 may be detected by an optical sensor (detecting unit) serving as the second rotation amount detecting unit and a detection signal (second signal) may be output from the optical sensor. A rotation amount (angular position), that is, the surface movement distance of the photosensitive member 21 may also be determined based on a detection result from the optical sensor. Alternatively, the rotation amount (angular position), that is, the surface movement distance of the photosensitive member 21 may also be determined based on the rotation position signal (second signal) 216 output from the rotation position detecting portion (second rotation amount detecting unit) 208. In this case, a relationship between a rotation amount of the drum motor 207 and the rotation amount of the photosensitive member 21 only needs to be determined in advance. A plurality of marks formed on a surface of a region of the intermediate transfer belt 13 excluding an image forming region along the rotation direction R of the intermediate transfer belt 13 may be detected by the optical sensor (detecting unit) serving as the second rotation amount detecting unit and the detection signal (second signal) may be output from the optical sensor. In this case, it is preferred that the intermediate transfer belt 13 be driven along with the rotation of the photosensitive member 21 without slippage. A rotation amount of the intermediate transfer belt 13, that is, the surface movement distance of the photosensitive member 21 may also be determined based on the detection result from the optical sensor.

Light Scanning Device

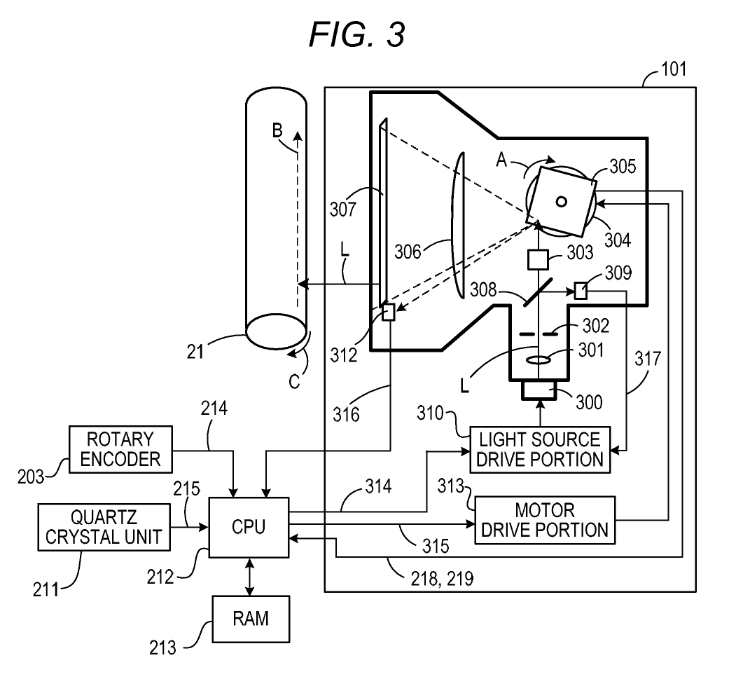

FIG. 3 is a block diagram illustrating a configuration of the light scanning device 101. The light scanning device 101 includes a semiconductor laser (hereinafter referred to as “light source”) 300, a rotary polygon mirror (deflecting member) 305 configured to deflect the light beam L from the light source 300, and a motor 304 configured to rotate the rotary polygon mirror 305. The light scanning device 101 includes an imaging lens (fθ lens) 306 configured to image the light beam deflected by the rotary polygon mirror 305 onto the photosensitive member 21. The light scanning device 101 further includes a light source drive portion 310 configured to drive the light source 300 and a motor drive portion 313 configured to drive the motor 304. The light scanning device 101 further includes a beam detector (hereinafter referred to as “BD”) 312 serving as a synchronous signal generating unit. The BD 312 is configured to output a synchronous signal (hereinafter referred to as “BD signal”) 316 in a direction indicated by the arrow B (hereinafter referred to as “main scanning direction B”) for maintaining a constant optical writing position (exposure start position) on the surface of the photosensitive member 21 in the main scanning direction B.

In FIG. 3, the light beam L emitted from the light source 300 is converted by a collimator lens 301 into a substantially collimated light beam. A stop 302 confines the substantially collimated light beam L to shape the light beam L. The shaped light beam L enters a half-silvered mirror 308. A part of the light beam L reflected by the half-silvered mirror 308 enters a photodiode (hereinafter referred to as “PD”) 309. The PD 309 outputs a light intensity signal 317 in accordance with light intensity of the light beam L to the light source drive portion 310. The light source drive portion 310 performs feedback control of the light intensity of the light beam L output from the light source 300 based on the light intensity signal 317. The light source drive portion 310 further controls light emission of the light source 300 in accordance with a light emission control signal 314 from the CPU 212.

The light beam L, which passes through the half-silvered mirror 308, enters a cylindrical lens 303 having predetermined refractive power only in the sub-scanning direction. The light beam L, which enters the cylindrical lens 303, is condensed in a sub-scanning cross section while keeping a state of the substantially collimated light beam in a main scanning cross section. The light beam L, which is emitted from the cylindrical lens 303, is imaged into a linear shape on a reflection surface (deflection surface) of the rotary polygon mirror 305.

The rotary polygon mirror 305 is rotated by the motor 304 in a direction indicated by the arrow A (hereinafter referred to as “rotation direction A”). The light beam L is reflected, that is, deflected by the reflection surface of the rotating rotary polygon mirror 305. The light beam L, which is deflected by the rotary polygon mirror 305, passes through the imaging lens 306 having fθ characteristics, and is imaged on the surface (surface to be scanned) of the photosensitive member 21 through a reflection mirror 307. The light beam L scans the surface of the photosensitive member 21 at a constant speed in the main scanning direction B. The photosensitive member 21 is rotated in a direction indicated by the arrow C (hereinafter referred to as “sub-scanning direction C”), and hence the light beam L forms an electrostatic latent image on the surface of the photosensitive member 21 in accordance with image information.

The light beam L deflected by the rotary polygon mirror 305 further enters the BD 312. The BD 312 receives the light beam L, and then outputs the BD signal 316 to the CPU 212.

The CPU 212 is configured to control the motor 304 in accordance with the surface movement distance of the photosensitive member 21 so as to change the rotation speed of the rotary polygon mirror 305. The CPU 212 outputs an acceleration/deceleration signal 315 to the motor drive portion 313. The motor drive portion 313 drives the motor 304 in accordance with the acceleration/deceleration signal 315. The acceleration/deceleration signal 315 is a signal for controlling a rotation amount of the motor 304. The CPU 212 generates the acceleration/deceleration signal 315 based on the BD signal 316 from the BD 312 and the encoder signal 214 from the rotary encoder 203.

Note that, the CPU 212 is electrically connected to an FG sensor and a Hall IC arranged in the motor 304. The CPU 212 receives an FG signal 218 from the FG sensor and a signal 219 from the Hall IC.

Control of Motor of Rotary Polygon Mirror

Next, control of the motor 304 configured to rotate the rotary polygon mirror 305 will be described. The CPU (comparator) 212 compares the BD signal (first signal) 316 and the encoder signal (second signal) 214 to change a rotation speed of the motor 304 based on a comparison result thereof. Specifically, the CPU 212 generates the acceleration/deceleration signal 315 for controlling the motor 304 based on a phase difference between the BD signal 316 and the encoder signal 214 and a comparison between a period of the BD signal 316 and a period of the encoder signal 214.

In the embodiment, a pulse interval of the encoder signal 214 or a scanning period by the rotary polygon mirror 305 is set so that the period of the encoder signal 214 and the period of the BD signal 316 have a relationship of synchronization or an integral multiple. Now, the relationship between the encoder signal 214 from the rotary encoder 203, which is fixed to the photosensitive member 21, and the BD signal 316 from the BD 312, which receives the light beam L deflected by the rotary polygon mirror 305, will be described.

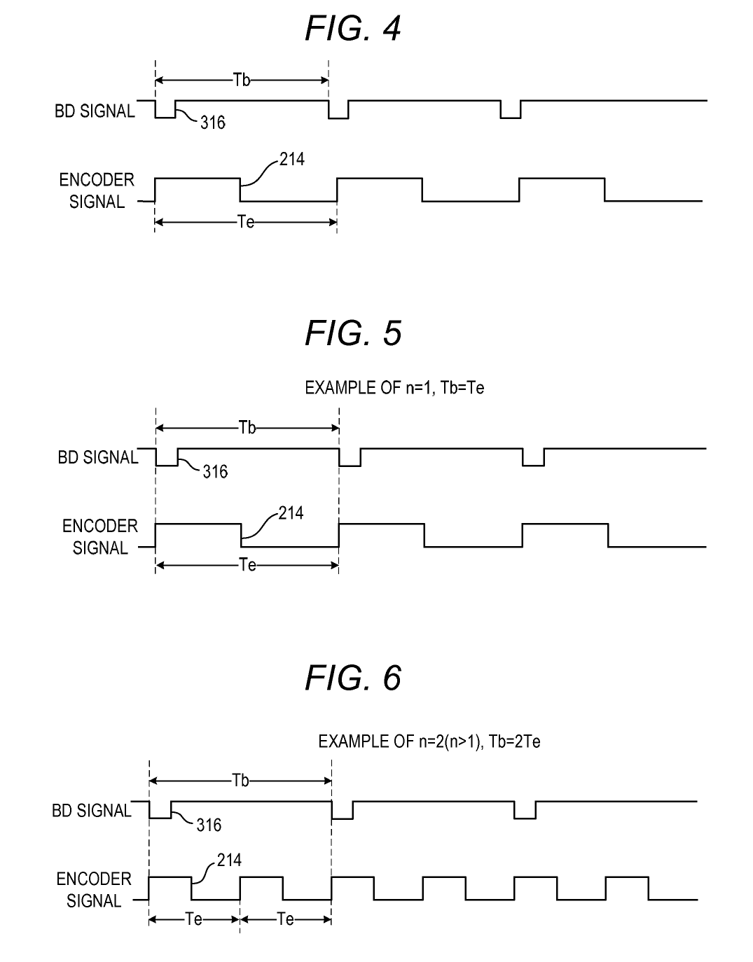

FIG. 4 is a diagram illustrating the relationship between the BD signal 316 and the encoder signal 214. The BD 312 receives the light beam L every time the light beam L is deflected by the rotary polygon mirror 305, and outputs the BD signal 316. When the number of the reflection surfaces of the rotary polygon mirror 305 is defined as Z, the BD 312 outputs Z BD signals 316 per one revolution of the rotary polygon mirror 305. That is, the BD 312 outputs one BS signal 316 per one Z-th revolution of the rotary polygon mirror 305. Therefore, the BD 312 is a rotation amount detecting device (first rotation amount detecting unit) configured to detect a rotation amount of the rotary polygon mirror 305.

A period in which the BD signal (first signal) 316 is output is hereinafter referred to as “one surface period Tb (second)”. The one surface period (first period) Tb corresponds to a scanning period of the light beam L that scans the photosensitive member 21. The one surface period Tb of the BD signal 316 is determined based on a number Bn of the light beams emitted from the light source 300 (number of light emission points), a resolution dpi of a scanning line in the sub-scanning direction C, and a conveyance speed Ps (millimeters per second) at which the recording medium S is conveyed. The one surface period Tb of the BD signal 316 is derived from Expression 1.

Tb=1/[{Ps×(dpi/Bn)}/25.4] (Expression 1)

In this expression, the value of 25.4 represents a millimeter-equivalent of 1 inch. When the number of the reflection surfaces of the rotary polygon mirror 305 is defined as Z, a period of one revolution of the rotary polygon mirror 305 is represented by Z×Tb (second). A rotation speed Vr of the rotary polygon mirror 305 is represented by Vr=1/(Z×Tb) (revolutions per second)=60/(Z×Tb) (revolutions per minute). That is, as the one surface period Tb of the BD signal 316 becomes longer, the rotation speed Vr of the rotary polygon mirror 305 becomes lower, and as the one surface period Tb of the BD signal 316 becomes shorter, the rotation speed Vr of the rotary polygon mirror 305 becomes higher.

Next, a pulse period (second period) Te (second) of the encoder signal (second signal) 214 will be described. The pulse period Te of the encoder signal 214 is determined based on a slit resolution Sn of the rotary encoder 203, a diameter Φ (millimeter) of the photosensitive member 21, and the conveyance speed Ps (millimeter per second) of the recording medium S. The pulse period Te of the encoder signal 214 is derived from Expression 2.

Te={(Φ×π)/Sn}/Ps (Expression 2)

The slit resolution Sn of the rotary encoder 203 corresponds to the number of the encoder signals 214 output while the photosensitive member 21 makes one revolution. Therefore, the rotary encoder 203 is a rotation amount detecting device (second rotation amount detecting unit) configured to detect the rotation amount of the photosensitive member 21.

The rotation speed of the photosensitive member 21 is set so that a movement speed (millimeters per second) of the surface of the photosensitive member 21 becomes equal to the conveyance speed Ps of the recording medium S. A rotation speed Vd of the photosensitive member 21 is represented by Vd=Ps/(Φ×π) (revolutions per second)=1/(Te×Sn) (revolutions per second)=60/(Te×Sn) (revolutions per minute). That is, as the pulse period Te of the encoder signal 214 becomes longer, the rotation speed Vd of the photosensitive member 21 becomes lower, and as the pulse period Te of the encoder signal 214 becomes shorter, the rotation speed Vd of the photosensitive member 21 becomes higher.

In the embodiment, the rotation speed Vr of the rotary polygon mirror 305 is controlled so that the light beam L scans the photosensitive member 21 in accordance with the surface movement distance of the photosensitive member 21. In this case, it is preferred that the encoder signal 214 and the BD signal 316 be synchronized with each other, or that the pulse period Te of the encoder signal 214 and the one surface period Tb of the BD signal 316 have the relationship of the integral multiple. That is, it is preferred that the pulse period Te and the one surface period Tb satisfy a relationship of Expression 3.

Tb=nTe (Expression 3)

In Expression 3, n represents an integer of 1 or more.

FIG. 5 is a diagram illustrating the relationship between the BD signal 316 and the encoder signal 214 in a case of n=1. In the case of n=1, the synchronization relationship is established between the BD signal 316 and the encoder signal 214, and hence the relationship between the one surface period Tb and the pulse period Te is represented by Tb=Te. In order that the encoder signal 214 and the BD signal 316 be synchronized with each other, the CPU 212 controls the rotation of the motor 304 by the motor drive portion 313 to change the rotation speed Vr of the rotary polygon mirror 305. That is, the CPU 212 controls the rotation of the motor 304 to maintain the relationship that the one surface period Tb is one time as large as (an integral multiple of) the pulse period Te. In this manner, the rotation amount of the rotary polygon mirror 305 is synchronized with the rotation amount of the photosensitive member 21. With this, computation for synchronization exposure control is simplified, with the result that the rotation speed Vr of the rotary polygon mirror 305 can be changed in accordance with a fluctuation of the rotation speed Vd of the photosensitive member 21 at a minimum phase delay. According to the embodiment, the light beam L can scan the photosensitive member 21 in accordance with the surface movement distance of the photosensitive member 21, and hence the light beam L can be radiated to a target exposure position on the photosensitive member 21. Accordingly, even when the rotation speed Vd of the photosensitive member 21 is changed, an image failure such as banding or color misregistration can be prevented.

In the case of n=1, similar effects can be attained also by changing the rotation speed Vr of the rotary polygon mirror 305 so that the pulse count of the BD signal 316 becomes equal to the pulse count of the encoder signal 214 during a period from the start to the end of optical writing on the image.

In a case of n>1, the one surface period Tb and the pulse period Te have the relationship that the one surface period Tb is n times as large as (an integral multiple of) the pulse period Te. Next, as an example of the case of n>1, a relationship between the BD signal 316 and the encoder signal 214 in a case of n=2 will be described. FIG. 6 is a diagram illustrating the relationship between the BD signal 316 and the encoder signal 214 in the case of n=2. In the case of n=2, the one surface period Tb is twice as large as (the integral multiple of) the pulse period Te, and hence the relationship between the one surface period Tb and the pulse period Te is represented by Tb=2Te. In order to generate two pulses in the encoder signal 214 during the one surface period Tb of the BD signal 316, the CPU 212 controls the rotation of the motor 304 by the motor drive portion 313 to change the rotation speed Vr of the rotary polygon mirror 305. That is, the CPU 212 controls the rotation of the motor 304 to maintain the relationship that the one surface period Tb is twice as large as (the integral multiple of) the pulse period Te. In this manner, the rotation amount of the rotary polygon mirror 305 is synchronized with the rotation amount of the photosensitive member 21. With this, the computation for the synchronization exposure control is simplified, with the result that the rotation speed Vr of the rotary polygon mirror 305 can be changed in accordance with the fluctuation of the rotation speed Vd of the photosensitive member 21 at the minimum phase delay. According to the embodiment, the light beam L can scan the photosensitive member 21 in accordance with the surface movement distance of the photosensitive member 21, and hence the light beam L can be radiated to the target exposure position on the photosensitive member 21. Accordingly, even when the rotation speed Vd of the photosensitive member 21 is changed, the image failure such as the banding or the color misregistration can be prevented.

In the embodiment, the CPU 212 changes the rotation speed Vr of the rotary polygon mirror 305 so that the one surface period Tb is synchronized with the pulse period Te while maintaining the relationship that the one surface period Tb is the integral multiple of the pulse period Te.

In the case of n=2, similar effects can be attained also by changing the rotation speed Vr of the rotary polygon mirror 305 so that the pulse count of the BD signal 316 becomes a half of the pulse count of the encoder signal 214 during the period from the start to the end of the optical writing on the image. Similarly, in a case of n>2, the similar effects can be attained also by changing the rotation speed Vr of the rotary polygon mirror 305 so that the pulse count of the BD signal 316 becomes one n-th of the pulse count of the encoder signal 214 during the period from the start to the end of the optical writing on the image.

According to the embodiment, the rotation amount of the rotary polygon mirror 305 can be synchronized with the rotation amount of the photosensitive member 21. That is, the rotation speed of the rotary polygon mirror 305 can be controlled so that a cumulative rotation amount of the rotary polygon mirror 305 becomes proportional to a cumulative rotation amount of the photosensitive member 21 from the start of the image formation. Accordingly, the image failure such as the banding or the color misregistration can be prevented.

In the embodiment, the case where the one surface period is equal to or longer than the pulse period (TbTe) will be described. This is because a resolution of the encoder signal 214 for determining the pulse period Te indicating the rotation speed Vd of the photosensitive member 21 is higher than that of the BD signal 316 for determining the one surface period Tb indicating the rotation speed Vr of the rotary polygon mirror 305. In this case, it is advantageous that the rotation speed Vr of the rotary polygon mirror 305 be changed in accordance with the fluctuation of the rotation speed Vd of the photosensitive member 21.

However, the one surface period may not necessarily be equal to or longer than the pulse period (Tb≧Te), and the one surface period Tb may be shorter than the pulse period Te (Tb<Te). In this case, it is preferred that the pulse period Te and the one surface period Tb satisfy a relationship of Expression 4 instead of Expression 3.

nTb=Te (Expression 4)

In Expression 4, n represents an integer of 1 or more. In order that the pulse period Te and the one surface period Tb satisfy the relationship of nTb=Te, the CPU 212 may change the rotation speed Vr of the rotary polygon mirror 305 through control of the rotation of the motor 304 by the motor drive portion 313. Also in this case, the similar effects can be attained.

According to the embodiment, the scanning period (one surface period Tb) of the rotary polygon mirror 305 can be set to the integral multiple or an integral submultiple of the pulse interval (Te) of the encoder signal 214. Accordingly, occurrence of the image failure can be prevented.

Note that, in the embodiment, the image forming apparatus 100 includes a plurality of the photosensitive members 21 and a plurality of the rotary polygon mirrors 305 correspondingly to the plurality of the photosensitive members 21. However, the image forming apparatus 100 may include one photosensitive member 21 and one rotary polygon mirror 305. Alternatively, the image forming apparatus may include a plurality of the photosensitive members 21 and one rotary polygon mirror 305 configured to deflect a plurality of the light beams for the plurality of the photosensitive members 21.

In the embodiment, the rotation speed Vr of the rotary polygon mirror 305 is changed in accordance with the rotation speed Vd of the photosensitive member 21. However, the rotation speed Vr of the rotary polygon mirror 305 may be changed in accordance with a fluctuation of a rotation speed Vb of the intermediate transfer belt (image bearing member) 13. In this case, the motor 304 of the rotary polygon mirror 305 can be controlled in a similar manner to that in the above-mentioned embodiment by fixing the rotary encoder to a rotary shaft of the drive roller 13a, which is configured to drive the intermediate transfer belt 13, to thereby obtain the encoder signal. With this, the similar effects to those of the above-mentioned embodiment can be attained.

In the embodiment, the BD 312 is used as the rotation amount detecting device (first rotation amount detecting unit) configured to detect the rotation amount of the rotary polygon mirror 305. However, the present invention is not limited thereto. The FG sensor configured to detect the rotation amount of the motor 304 may be used as the rotation amount detecting device (first rotation amount detecting unit) configured to detect the rotation amount of the rotary polygon mirror 305. The FG sensor is a pulse generating unit (frequency generating unit), which is provided opposite to a magnet provided on a rotor of the motor 304, and is configured to generate the FG signal (pulse) in accordance with the rotation amount of the motor 304. The rotation amount of the motor 304, that is, the rotation amount of the rotary polygon mirror 305 can be detected based on the FG signal (first signal) 218 from the FG sensor. Further, the Hall IC arranged in the motor 304 may be used as the rotation amount detecting device (first rotation amount detecting unit) configured to detect the rotation amount of the rotary polygon mirror 305. The Hall IC is a pulse generating unit, which is provided opposite to the magnet provided on the rotor of the motor 304, and is configured to generate the pulse (signal) in accordance with the rotation amount of the motor 304. The rotation amount of the motor 304, that is, the rotation amount of the rotary polygon mirror 305 can be detected based on the signal (first signal) 219 from the Hall IC.

According to the embodiment, the computation for the synchronization exposure control is simplified, with the result that the rotary polygon mirror can follow the photosensitive member at the minimum phase delay. As a result, the image failure such as the banding or the color misregistration can be prevented to provide a high-quality image.

According to the embodiment, the rotation amount of the rotary polygon mirror and the rotation amount of the photosensitive member can be synchronized with each other.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-095910, filed May 7, 2014, which is hereby incorporated by reference herein in its entirety.

What is claimed is:

1. An image forming apparatus, comprising:
a rotatable photosensitive member;
a light source configured to emit a light beam;
a rotary polygon mirror configured to deflect the light beam emitted from the light source so that the light beam scans a surface of the photosensitive member;
a motor configured to rotate the rotary polygon mirror;
a first rotation amount detecting unit configured to detect a rotation amount of the rotary polygon mirror; and
a second rotation amount detecting unit configured to detect a rotation amount of the photosensitive member,
wherein a first period of a first signal from the first rotation amount detecting unit and a second period of a second signal from the second rotation amount detecting unit have a relationship of an integral multiple, and
wherein a rotation speed of the motor is controlled so that the first signal and the second signal are synchronized with each other while maintaining the relationship of the integral multiple.

2. An image forming apparatus according to claim 1, wherein the second rotation amount detecting unit comprises a rotary encoder fixed to a rotary shaft of the photosensitive member.

3. An image forming apparatus according to claim 1, wherein the second rotation amount detecting unit comprises a detecting unit configured to detect a plurality of marks formed on the photosensitive member along a rotation direction of the photosensitive member.

4. An image forming apparatus according to claim 1, further comprising a comparator configured to compare the first signal and the second signal,
wherein the rotation speed of the motor is changed based on a comparison result of the comparator.

5. An image forming apparatus according to claim 1, wherein the first rotation amount detecting unit comprises a synchronous signal generating unit configured to receive the light beam to generate, as the first signal, a synchronous signal for optical writing on the surface of the photosensitive member with the light beam.

6. An image forming apparatus according to claim 1, wherein the first rotation amount detecting unit comprises a pulse generating unit configured to generate a pulse as the first signal in accordance with a rotation amount of the motor, the pulse generating unit being provided opposite to a magnet provided on a rotor of the motor.

7. An image forming apparatus according to claim 1, comprising:
a plurality of photosensitive members; and
a plurality of rotary polygon mirrors provided correspondingly to the plurality of photosensitive members.

8. An image forming apparatus, comprising:
a rotatable photosensitive member;
a light source configured to emit a light beam;
a rotary polygon mirror configured to deflect the light beam emitted from the light source so that the light beam scans a surface of the photosensitive member;
a motor configured to rotate the rotary polygon mirror;
a first rotation amount detecting unit configured to detect a rotation amount of the rotary polygon mirror;
an intermediate transfer member onto which a toner image is transferred from the photosensitive member, the intermediate transfer member being configured to transfer the transferred toner image onto a recording medium; and
a second rotation amount detecting unit configured to detect a rotation amount of the intermediate transfer member,
wherein a first period of a first signal from the first rotation amount detecting unit and a second period of a second signal from the second rotation amount detecting unit have a relationship of an integral multiple, and
wherein a rotation speed of the motor is controlled so that the first signal and the second signal are synchronized with each other while maintaining the relationship of the integral multiple.

9. An image forming apparatus according to claim 8, wherein the second rotation amount detecting unit comprises a rotary encoder fixed to a rotary shaft of the intermediate transfer member.

10. An image forming apparatus according to claim 8, wherein the second rotation amount detecting unit comprises a detecting unit configured to detect a plurality of marks formed on the intermediate transfer member along a rotation direction of the intermediate transfer member.

11. An image forming apparatus according to claim 8, further comprising a comparator configured to compare the first signal and the second signal,
wherein the rotation speed of the motor is changed based on a comparison result of the comparator.

12. An image forming apparatus according to claim 8, wherein the first rotation amount detecting unit comprises a synchronous signal generating unit configured to receive the light beam to generate, as the first signal, a synchronous signal for optical writing on the surface of the photosensitive member with the light beam.

13. An image forming apparatus according to claim 8, wherein the first rotation amount detecting unit comprises a pulse generating unit configured to generate a pulse as the first signal in accordance with a rotation amount of the motor, the pulse generating unit being provided opposite to a magnet provided on a rotor of the motor.

14. An image forming apparatus according to claim 8, comprising:
a plurality of photosensitive members; and
a plurality of rotary polygon mirrors provided correspondingly to the plurality of photosensitive members.
